(19) United States
(12) Patent Application Publication
(10) Pub. No.: US 2025/0218243 A1
(43) Pub. Date: Jul. 3, 2025

(54) SYSTEM INTERACTION WITH A MOVABLE BARRIER OPERATOR

(71) Applicant: The Chamberlain Group LLC, Oak Brook, IL (US)

(72) Inventors: James Citta, Lombard, IL (US); Paul Kuzich, Arlington Heights, IL (US); Nicholas Labianco, Aurora, IL (US)

(21) Appl. No.: 19/007,756

(22) Filed: Jan. 2, 2025

Related U.S. Application Data
(60) Provisional application No. 63/617,264, filed on Jan. 3, 2024.

(51) Int. Cl. G07C 9/28; G07C 9/00; G07C 9/10; G07C 9/29

(52) U.S. Cl. CPC G07C 9/28; G07C 9/10; G07C 9/29; G07C 2009/00317; G07C 2009/00928

(57) ABSTRACT

A method for affecting a state of a movable barrier, the method including receiving, at an access control device, an identifying information from an access point, the access control device configured to be transported by a vehicle; comparing, by the access control device, the received identifying information to a preferred identifying information set; determining, by the access control device, a status of the vehicle relative to a bounded area associated with a controllable movable barrier operator based on the comparing; and transmitting, by the access control device, information associated with the determined status of the vehicle relative to the bounded area, the notification configured to cause the user device to execute a control application associated with the controllable movable barrier operator to affect a state of a movable barrier.

### CROSS-REFERENCE TO RELATED APPLICATIONS

The present application claims priority to U.S. Provisional Patent Application Ser. No. 63/617,264 filed on Jan. 3, 2024, the disclosure of which is incorporated by reference herein in its entirety.

### FIELD

The present disclosure relates generally to system interaction with a movable barrier operator using an access control device.

### BACKGROUND

Movable barriers are used to secure environments, such as garages. The movable barrier is typically coupled to a movable barrier operator that opens and closes the movable barrier to allow and deny access to the secured environment. Traditionally, a user affects control of the movable barrier operator via a wireless transmitter (e.g., an RF transmitter) or a user device, such as an electronic device which may be a smart/cellular phone, tablet computer, laptop, wearable device and the like. The transmitter or user device communicates with the movable barrier operator to cause movement of the movable barrier.

Attempts to autonomously operate a movable barrier operator frequently result in less than desirable operation of the movable barrier operator. For example, when relying on geofencing techniques or when otherwise using the location, the position or proximity of a user device to automatically notify the movable barrier operator to open when a vehicle is returning to a home garage, the vehicle may arrive at the movable barrier prior to the movable barrier operator fully raising the movable barrier, causing the driver to wait before entering the garage. Similarly, when leaving a garage, the movable barrier operator may not close the movable barrier in a timely manner due to connectivity and/or latency issues associated with the user device. Delayed closure of the movable barrier may present opportunities for intruders to trespass and enter the garage, or even the house, residence, adjacent structure or area when attached to or accessible from the garage.

### BRIEF DESCRIPTION

Aspects of the invention in accordance with the present disclosure will be set forth in part in the following description, or may be obvious from the description, or may be learned through practice of the technology. One example aspect of the present disclosure is directed to a method for affecting a state of a movable barrier. The method includes receiving, at an access control device, an identifying information from an access point, the access control device configured to be transported by a vehicle; comparing, by the access control device, the received identifying information to a preferred identifying information set; determining, by the access control device, a status of the vehicle relative to a bounded area associated with a controllable movable barrier operator based on the comparing; and transmitting, by the access control device, a notification to a mobile communication device information associated with the status of the vehicle relative to the bounded area, the notification configured to cause the mobile communication device to execute a control application associated with the controllable movable barrier operator to affect a state of a movable barrier.

Another example aspect of the present disclosure is directed to a non-transitory computer-readable medium storing instructions which, when executed, cause performance of a method of affecting a state of a movable barrier system. The method includes receiving, at a mobile communication device, information associated with a status of a vehicle relative to a bounded area, wherein the information is received from an access control device transported by the vehicle; executing a control application, by a processor of the mobile communication device, in response to receiving the information; determining, by the processor of the mobile communication device, a location of the mobile communication device in response to executing the control application; comparing, via the control application, the determined location of the mobile communication device to a location of a bounded area; transmitting, by the mobile communication device, a signal to the movable barrier operator based on the comparing.

Another example aspect of the present disclosure is directed to an access control device configured to be disposed in a vehicle. The access control device includes a transmitter configured to communicate with a mobile communication device; and a processor in operable communication with a non-transitory computer-readable medium storing instructions, wherein the processor upon execution of the instructions is configured to: receive an identifying information associated with an access point; perform a comparison of the received identifying information to a preferred identifying information set; determine a status of the vehicle relative to a bounded area associated with a controllable movable barrier operator based on the comparison; and transmit a notification including information associated with the status of the vehicle relative to the bounded area to the mobile communication device, the notification configured to cause the mobile communication device to execute a control application associated with the controllable movable barrier operator to affect a state of a movable barrier.

Other example aspects of the present disclosure are directed to other systems, methods, apparatuses, non-transitory computer-readable media, and devices for affecting a state of a movable barrier. These and other features, aspects and uses of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

The detailed description that follows makes reference to the appended figures, in which:

FIG. 1 illustrates a garage, a movable barrier operator control system, and a bounded area outside the garage in which a vehicle is located according to embodiments of the present disclosure;

FIG. 2 is a schematic of a movable barrier operator control system in accordance with embodiments of the present disclosure;

FIG. 3 is a schematic of the movable barrier operator control system in accordance with embodiments of the present disclosure;

FIG. 4 is a flow chart of a startup procedure for an access control device in accordance with embodiments of the present disclosure;

FIG. 5 is a flow chart of a method of affecting a state of a movable barrier operator in accordance with embodiments of the present disclosure;

FIG. 6 is a schematic of a dense neighborhood including information associated with access points in accordance with embodiments of the present disclosure;

FIG. 7 is a flow chart of a method of affecting a state of a movable barrier operator in accordance with embodiments of the present disclosure;

FIG. 8 is a diagram depicting autonomous operation of a movable barrier operator in response to starting a vehicle in accordance with embodiments of the present disclosure; and

FIG. 9 is a flow chart of a method of forming a whitelist of access points in accordance with embodiments of the present disclosure.

### DETAILED DESCRIPTION

The embodiments set forth below represent the information to enable individuals to practice the embodiments. Upon reading the following description in light of the accompanying figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context.

Example aspects of the present disclosure are directed to systems, apparatuses, and methods of affecting the state of a movable barrier by a movable barrier operator. The system can include an access control device that is transported by a vehicle. The access control device can receive power from the vehicle when the vehicle is running, on, or otherwise active and initiate a startup procedure in response to receiving power, such as when the vehicle is powered on. In response to, or during, the startup procedure, the access control device can scan for and monitor connectivity with access points, such as WiFi routers or other wireless network-instantiating devices. The access control device may receive signals from one or more access points. At least some of the signal(s) can include identifying information unique to the respective transmitting access point. For example, the identifying information can include a service set identifier (SSID) or a MAC address. The access control device can compare information from the received signal(s), such as the received identifying information contained in the signal(s), to a preferred identifying information set. The preferred identifying information set may be saved at the access control device. The preferred identifying information set can include a database, list, table, or data structure with known identifying information. Each known identifying information can correspond with a unique identifier of a known (whitelisted) access point. Whitelisted access points may include, for example, access points located at the vehicle operator's house (e.g., a personal WiFi router, hereinafter referred to as a home access point), access points associated with one or more neighbor's houses, access points associated with nearby public infrastructure (such as libraries, government buildings and structures, etc), or the like. Where the received identifying information corresponds to identifying information included in the preferred identifying information set, the access control device can determine that the access control device, and thus the vehicle in which the access control device is being transported, is at a known location, e.g., relative to a bounded area.

In some instances, the known location may correspond to a garage associated with the home access point. For example, where the access control device initiates the startup procedure and detects identifying information associated with the home access point, the access control device can determine that the access control device is located at, or near the home access point. In other instances, the known location may correspond to a bounded area near the vehicle operator's house. For example, where the access control device receives identifying information that is determined to be from a nearby, known access point the access control device can determine that the access control device is located at, or near a bounded area in which the known access point is near, or within.

In response to determining the location of the access control device, and thus the location of the vehicle, the access control device can transmit a notification to a mobile communication device, the notification including information associated with the determined status of the vehicle, e.g., with respect to the bounded area. The notification can cause the mobile communication device to execute a control application or client application that is associated with a controllable device, such as a controllable movable barrier operator that controls a position of a movable barrier of the garage at the vehicle operator's house, to affect a state of the movable barrier.

By way of one example, when the access control device initially receives power, e.g., when the vehicle is started, and determines proximity to the home access point, the notification transmitted to the mobile communication device may cause the control application to send a signal to the movable barrier operator which causes the movable barrier operator to open the movable barrier. In such a manner, the movable barrier operator can open (raise) the movable barrier and allow the vehicle to exit the garage. The vehicle can then travel away from the garage to a remote location. As the vehicle travels from the garage and exits a broadcast range of the home access point, the access control device loses signal with the home access point. At such time, or at an offset time, the access control device can transmit a notification to the mobile communication device which causes the control application to send a signal to the movable barrier operator which causes the movable barrier operator to close the movable barrier.

By way of another example, when the access control device initially receives power and cannot confirm proximity to the home access point, the access control device continues to scan and monitor for received identifying information. For instance, the vehicle may be away from the garage (e.g., the vehicle operator may be at work or at other remote location). As the vehicle moves, the access control device receives identifying information from nearby access points. The received identifying information is compared (e.g., on a rolling basis, continuously, regularly, or periodically) to the preferred identifying information set. When the received identifying information does not correspond to identifying information that is part of the preferred identifying information set, the access control device takes no action with respect to the mobile communication device and continues to scan and monitor for signals received from access points. When the received identifying information is determined to correspond to identifying information included in the preferred identifying information set, the access control device transmits a notification to the mobile communication device which causes the control application or client application to send a signal to the movable barrier operator which causes the movable barrier operator to open the movable barrier. Thus, the movable barrier is in the open state (or moving towards the open state) when the vehicle arrives at the garage. The state of the movable barrier when the vehicle arrives at the garage may be controlled by adjusting one or more control parameters, such as a size of the bounded area triggering the transmission of the notification to the mobile communication device. The larger the bounded area, the sooner the access control device can be triggered in an arrival condition to transmit the notification to the mobile communication device to affect the movable barrier to the open state.

Access control devices and associated systems and methods described herein can reduce latency when autonomously operating a movable barrier operator to affect the state of a movable barrier. The access control device can rely on a triggering event associated with starting a connected vehicle to initiate a process of autonomous operation. The access control device may be programmable, e.g., through a control application executed by the mobile communication device or through another user device, to set parameters and operational characteristics. For instance, a user may adjust triggering events associated with transmission of the notification from the access control device to the mobile communication device. The user may also, or alternatively, adjust a position of the bounded area relative to one or more conditions, factors, or parameters such as an arrival condition versus a departure condition. The user may also, or alternatively, add or confirm identifying information associated with one or more detected access points to the preferred identifying information set to adjust an access point whitelist.

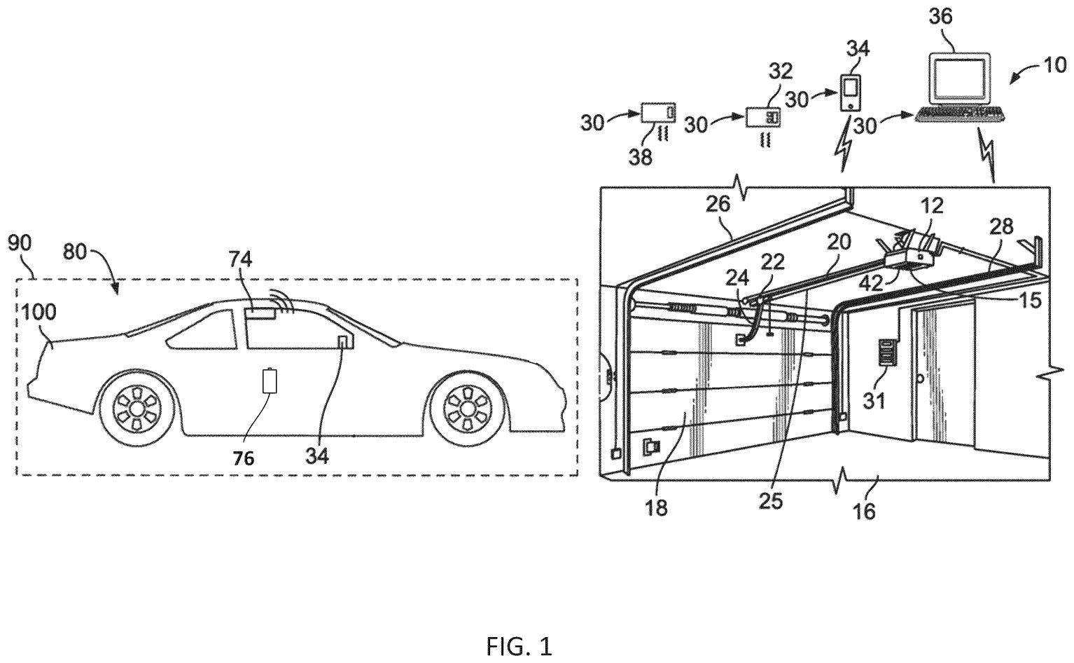

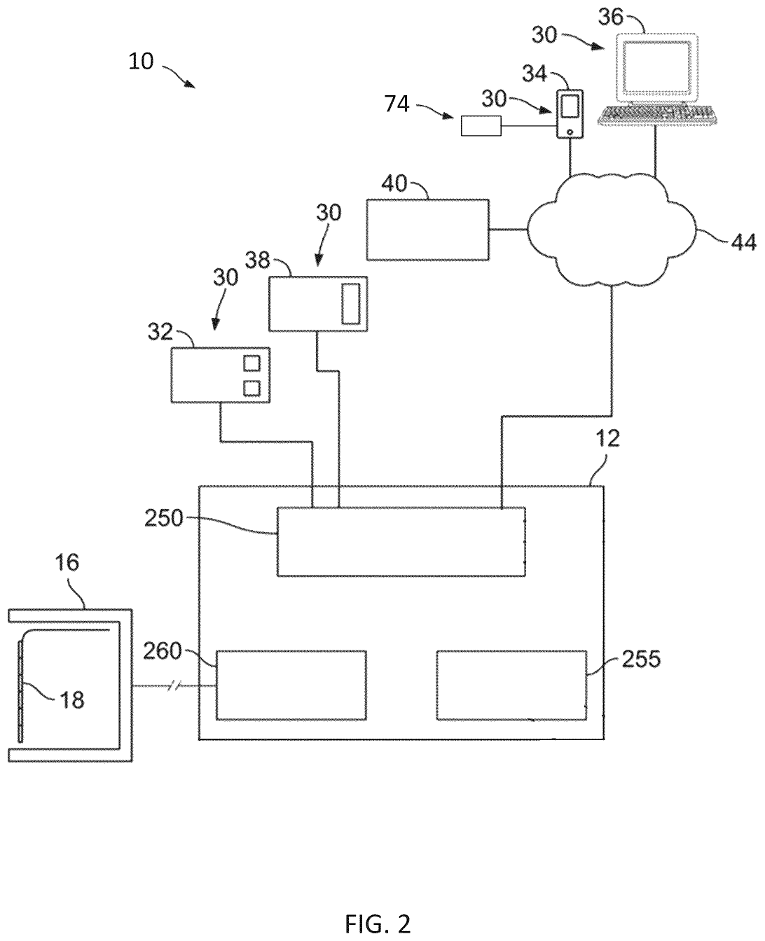

Referring now to the drawings, FIG. 1 illustrates a movable barrier operator system 10 including a movable barrier operator 12. The movable barrier operator 12 is shown mounted to the ceiling of a garage 16 and controls the position of a movable barrier 18. The movable barrier operator 12 further includes a motor 260, communication circuitry 250, and a controller 255 (FIG. 2). The movable barrier operator system 10 includes a rail 20 and trolley 22. The trolley 22 has an arm 24 that is connected to the movable barrier 18. A coupling 25 such as a belt or chain connects the trolley 22 to an output (e.g. drive shaft or transmission) of the motor 260. The movable barrier 18 is positioned for movement along a pair of tracks 26 and 28. In response to receiving a command message from a remote control 30, such as a handheld transmitter 32, the movable barrier operator 12 changes the state of the movable barrier 18. For example, the movable barrier operator 12 moves the movable barrier 18 from an open position to a closed position and vice versa.

The communication circuitry 250 of the movable barrier operator 12 is configured to communicate with one or more remote controls 30. The one or more remote controls 30 may include, for example, a wall-mounted keypad 31, a handheld transmitter 32, a mobile communication device 34 (such as a smartphone), a remote computer 36 (such as a desktop or laptop), a vehicle integral (e.g., HomeLink®-style) transmitter 38, and/or a security system associated with the garage 16. The one or more remote controls 30 are configured to communicate directly or indirectly with the movable barrier operator 12 to effect a change of the state of the movable barrier 18. The remote controls 30 may send a communication that includes at least: an identifier portion to identify the remote control 30 sending the communication; and a rolling code portion that changes with each command message sent by the remote control 30. For example, the handheld transmitter 32 may send a communication that may be a radio frequency signal including a command message having an identifier portion and a rolling code portion.

The remote controls 30 may communicate directly with the movable barrier operator 12, such as with radio frequency signals. Alternatively, or additionally, the remote controls 30 may communicate indirectly with the movable barrier operator 12 such as via a network 44 and a server computer 40 (see FIG. 2). The network 44 may include wired or wireless networks (or a combination thereof), for example, the internet or a local area network. For example, the handheld transmitter 32 may communicate directly with the movable barrier operator 12 via radio frequency signals such that when the handheld transmitter 32 is out of range, the movable barrier operator 12 will not receive a communication from the handheld transmitter 32 and will not affect movement of the movable barrier 18. However, the mobile communication device 34, such as a smartphone, may instead communicate indirectly with the movable barrier operator 12 to effectively increase the range of operation. Specifically, the mobile communication device 34 communicates a state change request to the server computer 40 and the server computer 40 communicates a command message to the movable barrier operator 12 via the network 44. Similarly, a remote computer 36 or a security system may communicate indirectly with the movable barrier operator 12 via the network 44 and the server computer 40. Upon receiving the command message, the movable barrier operator 12 changes the state of the movable barrier 18 using the motor 260.

Regarding FIGS. 1 and 2, the movable barrier operator system 10 moves the movable barrier 18 depending on whether a particular remote control of the remote controls 30 has been actuated and is within a physical proximity of a location 80 associated with the movable barrier operator system 10. Whether the remote control 30 is within the physical proximity of the location 80 may be utilized as a proxy to determine whether a user associated with the remote control 30 is within the physical proximity of the location 80. As such, references herein to determining whether the remote control or user is within a physical proximity of a location are intended to be used interchangeably. In one embodiment, the location 80 may be a geofenced (bounded) area 90 near the garage 16. The user's home may have a driveway extending between the garage 16 and a street and the geofenced area 90 may include, for example, a portion of the street and portions of the surrounding environment. FIG. 1 shows a vehicle 100 that is experiencing an arriving/arrival condition-driving through the geofenced area 90 toward the garage 16.

The movable barrier operator system 10 includes communication circuitry 250 configured to receive a communication from a remote control 30 associated with the movable barrier operator system 10. Upon the communication circuitry 250 receiving the communication, the controller 255 of the movable barrier operator 12 is configured to cause the motor 260 to effect movement of the movable barrier 18.

A user may define the geofenced area 90 using, for example, the mobile communication device 34 or the remote computer 36. The geofenced area 90 may be defined as a boundary of the garage 16, a boundary associated with a driveway leading up to the garage 16, a boundary associated with a property perimeter, a boundary of a portion of a neighborhood in which the garage 16 is located, or a custom boundary surrounding a custom bounded zone. In some instances, the geofenced area 90 can be manually defined. For example, the user may position markers on a digital representation of an area near or surrounding the garage 16. The markers can include, for example, markers associated with corners of a desired geofenced area 90. The mobile communication device 34, directly or indirectly, then form boundary lines that extend between the markers to form enclosed boundaries of the geofenced area 90. Alternatively, or in addition, the user can move one or more fingers across a touchscreen display of the mobile communication device 34 (or use a cursor on a remote computer 36) to draw boundary lines over a digital representation of the area near or surrounding the garage 16. In some instances, the user may select a shape with a fixed dimension which is assigned as the boundary of the geofenced area 90. By way of example, the shape can be in the form of an oval (e.g., a circle), a square, a triangle, etc. Yet other methods of generating boundary lines of the geofenced area 90 may be used without departing from the scope of the disclosure. Additionally, there may be more than one geofenced boundary. For example, there may be an arrival boundary and a departure boundary. The departure boundary may have a different size than the arrival boundary. In an embodiment, one of the boundaries can be nested within the other boundary.

By way of non-limiting example, in a densely packed urban area, the bounds of the geofenced area 90 may be defined by the user to include a block or multi-block radius in which the garage 16 is located, e.g., centrally located. In this embodiment, physical proximity refers to whether the coordinates (e.g., GPS or GNSS latitude and longitude) of the remote control 30 indicate that the remote control 30 is within the bounds of the geofenced area 90 as defined by a user.

As described above, in some instances, the user may cause the movable barrier operator 12 to raise and lower the movable barrier 18 using a remote control 30. Where the remote control is a mobile communication device 34, the user can manually affect the state of the movable barrier 18 by interacting with a user interface of the mobile communication device 34, e.g., selecting a virtual or digital button of a client application running on the device 34 for controlling the movable barrier operator 12 wherein the button is associated with raising and/or lowering the movable barrier 18. The user can also rely on the geofenced area 90 to allow the mobile communication device 34 to automatically change a state of the movable barrier 18 in response to a status (or change in status) of the mobile communication device 34 relative to the geofenced area 90. For example, the mobile communication device 34 can monitor a location of the mobile communication device 34 relative to the geofenced area 90 and automatically transmit a signal to the movable barrier operator 12 when exiting the geofenced area 90 to cause the movable barrier operator 12 to close the movable barrier 18 without user intervention. By way of another example, the mobile communication device 34 can automatically transmit a signal to the movable barrier operator 12 without user intervention when entering the geofenced area 90 to cause the movable barrier operator 12 to open the movable barrier 18.

While automating opening and closing of the movable barrier 18 based on a physical position (or change in physical position) of the mobile communication device 34 relative to the geofenced area 90 reduces the number of steps performed by the user to open and close the movable barrier 18, there are several drawbacks that occur as a result of latency and connectivity issues. For example, in instances where the mobile communication device 34 has low signal strength when entering or exiting the geofenced area 90 or where a positioning system of the mobile communication device is inactive (e.g., in a sleep mode to conserve battery), the user may travel a significant distance relative to the boundary of the geofenced area 90 before the mobile communication device 34 detects the changed status of the vehicle relative to the geofenced area 90 and is able to affect the state change of the movable barrier 18. For instance, when the vehicle 100 is entering the geofenced area 90 and the mobile communication device 34 has insufficient signal strength or the positioning system thereof is inactive, the mobile communication device 34 may not be able to determine a position of the vehicle 100, thus losing the ability to determine whether the vehicle 100 has entered the geofenced area 90. As a result, the movable barrier 18 may not be in the open position when the vehicle 100 arrives at the garage 16, inconveniencing the vehicle driver by experiencing a wait for the movable barrier 18 to open. Conversely, when the vehicle 100 is exiting the geofenced area 90 and the mobile communication device 34 has insufficient signal strength or the positioning system is inactive, the mobile communication device 34 may not be able to determine a relative position of the vehicle 100, thus losing the ability to determine whether the vehicle 100 has exited the geofenced area 90. As a result, the movable barrier 18 may remain in the open position for an unnecessarily long duration of time.

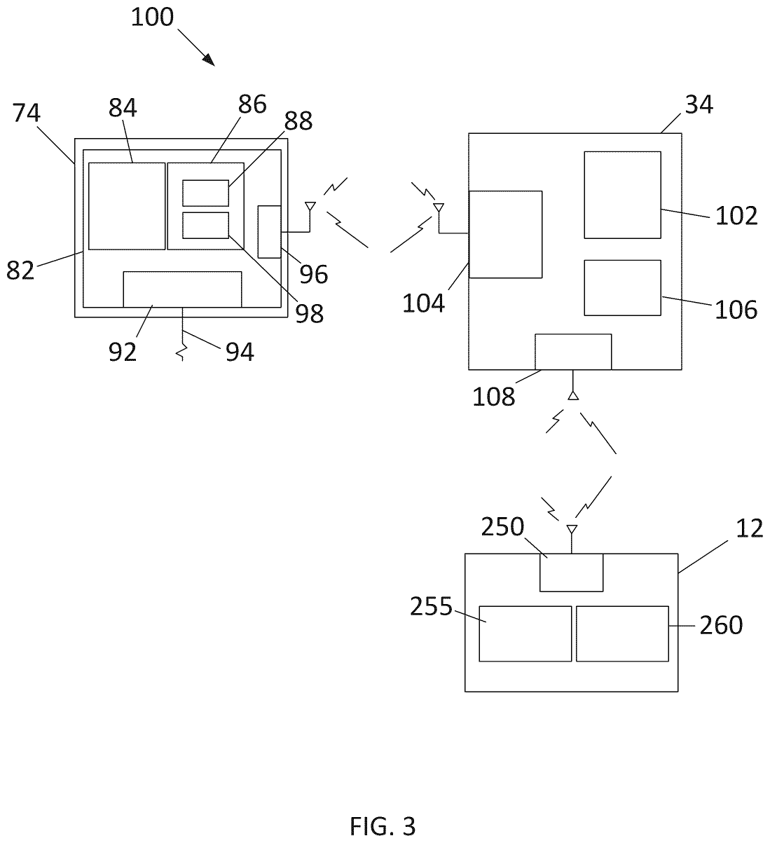

In an embodiment, the movable barrier operator system 10 can further include an access control device 74. The access control device 74 can assist the mobile communication device 34 in facilitating a state change of the movable barrier operator 12. The access control device 74 can be disposed in, at, or on the vehicle 100. For example, the access control device 74 can be positioned in the cabin of the vehicle, such as in a glovebox, a center console, a storage pocket in a seat back, or the like. The access control device 74 can have a protective shell (housing) defining an interior volume in which control circuitry 82 (FIG. 3) is housed. Referring to FIG. 3, the control circuitry 82 can include, for example, a processor 84 coupled to a memory 86. The processor(s) 84 can be any suitable processing device (e.g., a control circuitry, a processor core, a microprocessor, an application specific integrated circuit, a field programmable gate array, a controller, a microcontroller, etc.) and can be one processor or a plurality of processors that are operatively connected. The memory 86 can include one or more non-transitory computer-readable storage media, such as RAM, ROM, EEPROM, EPROM, one or more memory devices, flash memory devices, etc., and combinations thereof. The memory 86 can store information that can be accessed by the processor(s) 84. For instance, the memory 86 (e.g., one or more non-transitory computer-readable storage mediums, memory devices) can include computer-readable instructions 88 that can be executed by the processor(s) 84. The instructions 88 can be software, firmware, or both written in any suitable programming language or can be implemented in firmware or hardware. Additionally, or alternatively, the instructions 88 can be executed in logically and/or virtually separate threads on processor(s) 84. For example, the memory 86 can store instructions 88 that when executed by the processor(s) 84 cause the processor(s) 84 to perform operations such as any of the operations and functions as described herein.

The access control device 74 can be coupled to a power source 76 of the vehicle 100 (FIG. 1). By way of example, the power source 76 can include a vehicle battery, e.g., receiving power from an alternator coupled to an engine or a rechargeable primary battery system such as found in an electric vehicle (EV). The access control device 74 can include a power input 92 (FIG. 3) configured to be electrically coupled to the power source 76, e.g., through an integral or unitary interface, via a cable 94 (e.g., having a USB-A connector, USB-B connector, a USB-C connector, a cigarette lighter adapter, a two-or three-pronged interface, or another connector type) or a wireless charging interface. When the vehicle 100 is inactive, not started or running, or otherwise off, the access control device 74 does not receive power from the power source 76. When the vehicle 100 is on, the access control device 74 receives power from the power source 76. In some instances, power can be received by the access control device 74 from the power source 76 in response to starting the vehicle 100. In some instances the access control device 74 may be an apparatus that is not original equipment to the vehicle but is a supplemental, add-on product that may be purchased or otherwise obtained by the user or owner of the vehicle 100 and subsequently interfaced with the vehicle (e.g., via at least one of a mount or coupling, a vehicle power source, and/or vehicle communication circuitry such as a CAN bus, LIN bus, etc.). In other instances the access control device 74 may be an apparatus that is original equipment or otherwise unitary to the vehicle such that the access control device 74 is hardwired to vehicle power and/or communication circuitry. In an example, the access control device 74 may be integrated with a vehicle infotainment system which includes a user interface a first transceiver (e.g., Bluetooth) for short-range communications with a user device, and a second transceiver (e.g., WiFi) for longer-range communications with access points.

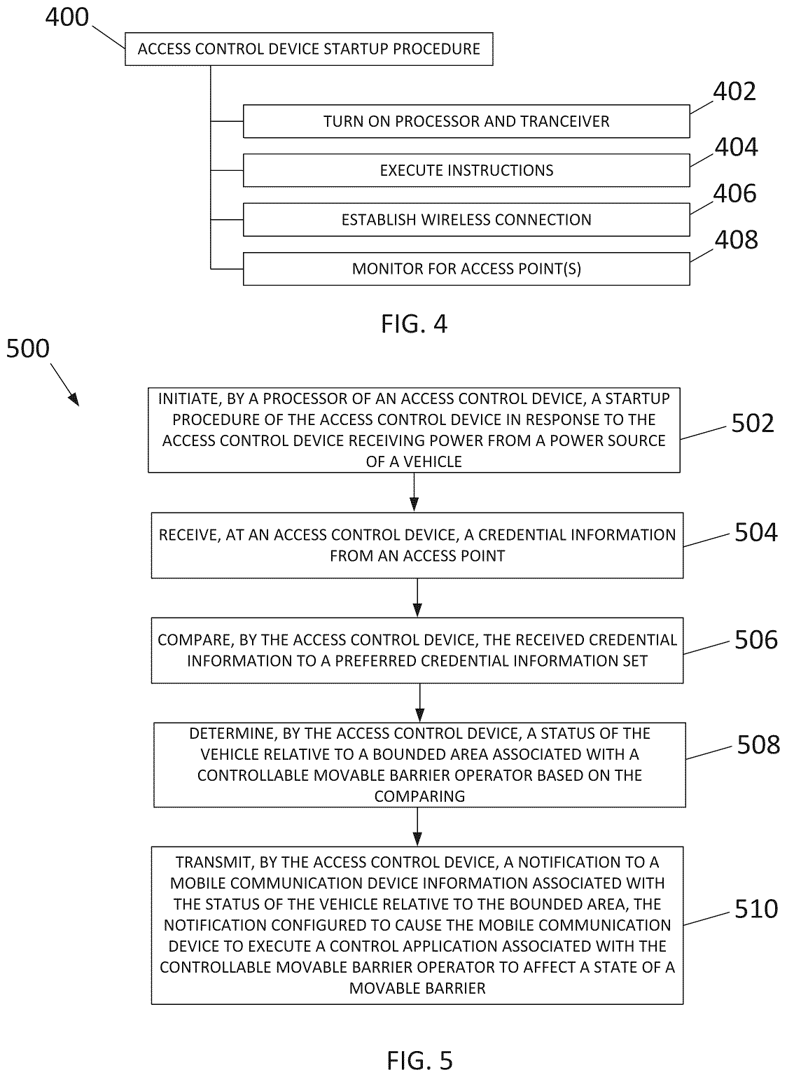

Referring to FIG. 4, the access control device 74 can initiate a startup procedure 400 in response to receiving power from the power source 76, e.g., when the vehicle 100 is started or when the access control device 74 is coupled to the power source 76. The startup procedure may occur automatically in response to receiving power. Although FIG. 4 depicts operations performed in a particular order for purposes of illustration and discussion, the method discussed herein is not limited to any particular order or arrangement. One skilled in the art, using the disclosure provided herein, will appreciate that various steps of the method disclosed herein can be omitted, rearranged, combined, and/or adapted in various ways without deviating from the scope of the present disclosure.

The startup procedure 400 can include turning on 402 the processor 84 and a transceiver 96 (FIG. 3) of the access control device 74. In some instances, the processor 84 and transceiver 96 can be turned on simultaneously, or at a generally same time. The processor 84 can execute 404 instructions 88 stored in the memory 86. The access control device 74, e.g., the transceiver 96, can establish wireless connection 406 with the remote control 30, such as the mobile communication device 34. By way of non-limiting example, the transceiver 96 can communicate with the mobile communication device 34 through Bluetooth or other short-range, local, point-to-point wireless connection such as infrared, WiFi, or NFC.

As part of the startup procedure 400, the access control device 74, e.g., the transceiver 96, can monitor 408 for one or more access points to determine whether the access control device 74 is at a known location as described below in greater detail. In some implementations, the access control device 74 can indicate a status of the access control device 74 to the user. For example, the access control device 74 can include one or more indicators (e.g., lights) that illuminate to convey status information to the user. The access control device 74 may indicate initiation of the startup procedure, completion of the startup procedure, notify the user of any issues, or the like. In an embodiment, the access control device 74 can also indicate a status of monitoring 408, such as when an access point is detected, or when a whitelisted access point is detected as described below.

FIG. 5 illustrates a flow diagram of a method 500 for affecting a state of a movable barrier according to example embodiments of the present disclosure. In general, the method 500 will be described with reference to a system including the movable barrier operator 12, the mobile communication device 34, and the access control device 74 described above with reference to FIGS. 1 to 4. In addition, although FIG. 5 depicts steps performed in a particular order for purposes of illustration and discussion, the method discussed herein is not limited to any particular order or arrangement. One skilled in the art, using the disclosure provided herein, will appreciate that various steps of the method disclosed herein can be omitted, rearranged, combined, and/or adapted in various ways without deviating from the scope of the present disclosure.

The method 500 can include initiating 502, by a processor of the access control device, a startup procedure of the access control device in response to the access control device receiving power from a power source of a vehicle. The startup procedure can include any one or more aspects of procedure 400 as described with respect to FIG. 4. In some implementations, the access control device is coupled to a power source of the vehicle (e.g., via an auxiliary power port associated with the vehicle). In other implementations, the access control device can be coupled with or include a separate power source. The access control device may not receive power when the vehicle is in an inactive (e.g., not running or off) state. When the user turns the vehicle to an active (e.g., running/idling or on) state (e.g., by turning a key or initiating a push start feature of the vehicle), power is transmitted to the access control device and received at a power input 92 of the access control device.

The method 500 can further include receiving 504, at the access control device, an identifying information from an access point, e.g., in response to monitoring 408 for access point(s) during the startup procedure of the access control device as depicted in FIG. 4. The identifying information can include, for example, a service set identifier (SSID), a MAC address associated with the access point, or the like. As described above, the access control device can be stored in, on, or at a vehicle such that the access control device moves with the vehicle. Thus, the location of the access control device is associated with the location of the vehicle at any given time. As the vehicle moves within an environment, the access control device receives identifying information from nearby access points.

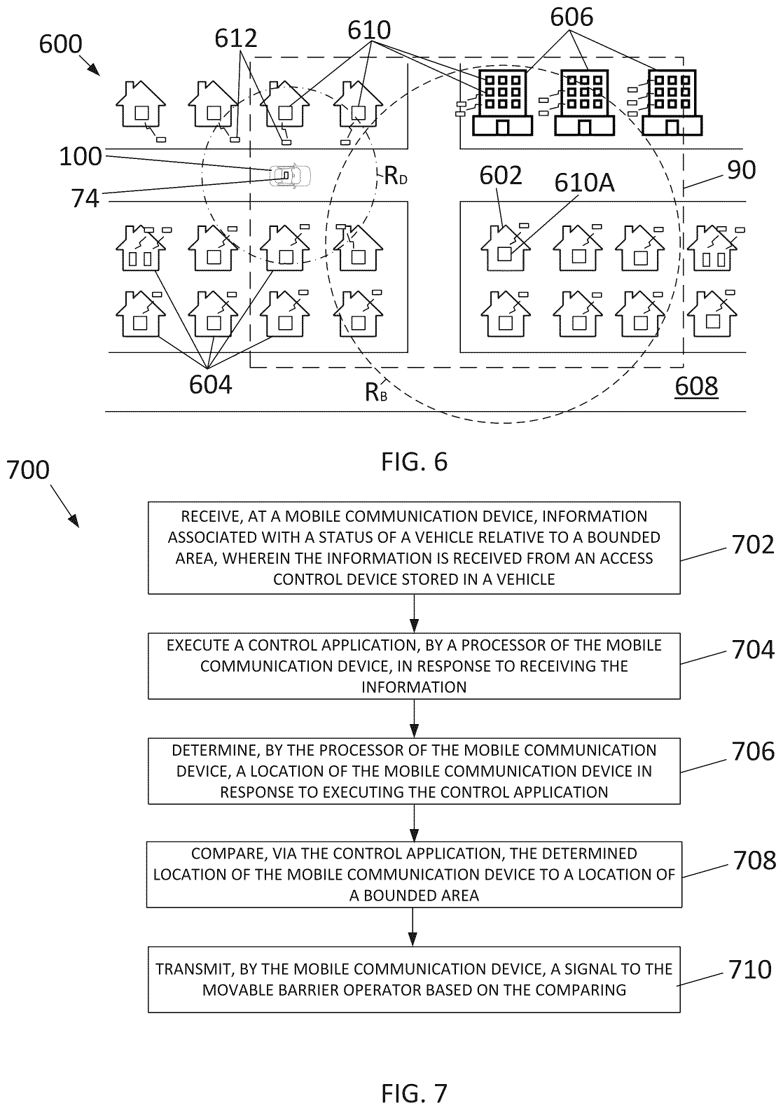

For example, referring to FIG. 6, the vehicle 100 may travel within a dense neighborhood 600 in route to a driver's house 602 where the vehicle 100 is to be parked. The neighborhood 600 can include a plurality of single-family houses 604 and multifamily dwellings 606 adjacent to a road system 608. The neighborhood 600 can also include public infrastructure (e.g., parks, public facilities, etc.), industrial buildings, office buildings, and the like. It is common for each house 604 and dwelling 606 (and oftentimes each infrastructure, industrial building and office building) to include at least one access point 610, such as a WiFi router, and in some instances, a plurality of access points 610, to provide user devices with wireless access to networks, such as the Internet. While FIG. 6 depicts at least one access point 610 associated with each house 604 and dwelling 606, it should be understood that in certain instances, one or more of the houses 604 or dwellings 606 may not include an access point 610 or the access point 610 may not be active. Each active access point 610 periodically transmits beacon signals 612, e.g., every 100 milliseconds, that broadcast within a broadcast range R_{B}. It is noted that the range R_{B} of broadcast may vary based, e.g., on hardware limitations associated with the access point, environmental considerations (such as the location of walls, trees, and other signal blocking features disposed in the nearby environment), etc. The beacon signals 612 contain identifying information including, but not limited to, an SSID associated with the access point 610. Each identifying information is particular to the specific broadcasting access point 610 and uniquely identifies that access point 610 to receiving devices.

The access control device 74 is disposed in the vehicle 100 and has a detection range R_{D} in which the access control device 74 can detect signals, such as beacon signals 612 broadcast from access points 610. As the vehicle 100 travels within the neighborhood 600, the access control device 74 receives signals, e.g., beacon signals 612, that are broadcast within the detection range R_{D}. For instance, the access control device 74 depicted in FIG. 6 receives beacon signals 612 from access points 610 associated with six houses 604. As the vehicle 100 moves within the neighborhood 600, the particular access points 610 and the number of access points 610 to which the vehicle 100 is proximate change. Eventually, the vehicle 100 approaches the driver's house 602 and the access control device 74 receives a signal from a home access point 610A associated with the driver's house 602. Prior to receiving a signal from the home access point 610A, the access control device 74 receives signals including identifying information from multiple different access points 610 as the vehicle 100 moves through the neighborhood 600.

Referring again to FIG. 5, the method 500 can further include comparing 506, by the access control device, the received identifying information to a preferred identifying information set. The access control device can store the preferred identifying information set in memory (see, e.g., preferred identifying information set 98 in FIG. 3). The preferred identifying information set can include identifying information associated with one or more known (whitelisted) access points. For example, the preferred identifying information can include an SSID associated with a home access point (see, e.g., access point 610A in FIG. 6). The preferred identifying information set can also, or alternatively, include identifying information (e.g., SSIDs) associated with a plurality of different access points. For example, the preferred identifying information set can include identifying information associated with access point(s) of one or more neighbors (see, e.g., access points 610 associated with houses 604 in FIG. 6), identifying information associated with one or more public access points, identifying information associated with one or more business access points, or the like. In an embodiment, the various identifying information can generally be associated with access points in, at, or near a bounded area (such as the geofenced area 90).

In some implementations, comparing 506 the received identifying information to the preferred identifying information set can be performed by a processor(s) of the access control device. For example, in response to receiving 504 the identifying information, the access control device can query the preferred identifying information set to compare the received identifying information to the known identifying information of whitelisted access points. In some implementations, querying can be performed on a rolling basis as the identifying information is received 502. In other implementations, querying can be performed at preset intervals or upon occurrence of one or more different triggering conditions. By way of example, the preset intervals can include every 1 second, every 5 seconds, every 10 seconds, or the like. Use of relatively shorter intervals (like every 1 second or every 5 seconds) may allow the access control device to perform the method 500 with greater precision, particularly when the preferred identifying information set includes identifying information associated with whitelisted access points within a small radius of the vehicle's home access point.

Comparing 506 the received identifying information to the preferred identifying information set can return information that allows the access control device to determine a relative status of the access control device and/or vehicle relative to the bounded area. For example, the method 500 can further include determining 508, by the access control device, a status of the vehicle relative to the bounded area based on the comparing 506. The determined status can include, for example, an in-bounds status where the vehicle 100 is determined to be within the bounded area, an out-of-bounds status where the vehicle 100 is determined to be outside the bounded area, a transition status, where the vehicle 100 is determined to be entering or exiting the bounded area, etc. As described above, comparing 506 the receiving identifying information to the preferred identifying information set can indicate whether the received identifying information is contained in the preferred identifying information set. In instances where the received identifying information is contained in the preferred identifying information set, the determined 508 status of the vehicle may be within the bounded area. In instances where the received identifying information is not contained in the preferred identifying information set, the determined 508 status of the vehicle may be outside the bounded area.

The method 500 can further include transmitting 510, by the access control device, a notification to a mobile communication device. The notification can include information associated with or based on the determined 508 status of the vehicle relative to the bounded area. The transmitted 510 notification is configured to cause the mobile communication device to execute a control application or client application associated with the controllable movable barrier operator to affect a state of the movable barrier operator.

The mobile communication device can include and execute a control application or client application (which is native to the mobile communication device or otherwise downloaded and installed from a remote resource such as an application store) associated with the controllable movable barrier operator. The control application can be used to affect control of the controllable movable barrier operator. The control application may have a graphical user interface (GUI) that is displayed to a user when the user opens the control application. The GUI may indicate status information of the controllable movable barrier operator such as whether the associated movable barrier state/status is open or closed, a history of state/status changes, whether the movable barrier operator is online, whether maintenance may be warranted, etc. To manually control the controllable device, the user may execute (open) the control application and provide a user input (e.g., tap, swipe, gesture) to request a state change of the controllable device. In response, the control application initiates the requested state of change of the controllable device, here the movable barrier operator. In response to the initiation of the requested state change, the mobile communication device can communicate with the controllable device, e.g., over a network (see, e.g., network 44 in FIG. 2). The network may include one or more networks such as wide area networks (e.g., cellular, WiMAX, LoRaWAN), local area networks (e.g., a home WiFi or WiLAN network), a fiber optic network, and the internet. The network is connected to one or more remote servers, the mobile communication device, and the controllable device. The remote servers may include one or more computers that provide functionality for an application on the mobile communication device, such as the control application. The remote servers may also provide functionality for the controllable device.

FIG. 7 illustrates a flow diagram of a method 700 for affecting a state of a movable barrier operator without user intervention or manual control according to example embodiments of the present disclosure. In general, the method 700 will be described with reference to a system including the movable barrier operator 12, the mobile communication device 34, and the access control device 74 described above with reference to FIGS. 1 to 4. In addition, although FIG. 7 depicts steps performed in a particular order for purposes of illustration and discussion, the method discussed herein is not limited to any particular order or arrangement. One skilled in the art, using the disclosure provided herein, will appreciate that various steps of the method disclosed herein can be omitted, rearranged, combined, and/or adapted in various ways without deviating from the scope of the present disclosure.

The method 700 can include receiving 702, at the mobile communication device, information associated with a status of the vehicle relative to the bounded area. The information can be received from the access control device transported by the vehicle at a communication interface of the mobile communication device (see, e.g., communication interface 104 in FIG. 3). The communication interface can include any circuits, components, software, etc. for communicating with the transceiver of the access control device. In some implementations, the communication interface can include for example, one or more of a communications controller, receiver, transceiver, transmitter, port, conductors, software and/or hardware for communicating data/information.

In some implementations, the information can be received 702 at the mobile communication device in response to the access control device transmitting 510 the notification to the mobile communication device as depicted in FIG. 5. The method 700 can further include executing 704 the control application, by a processor of the mobile communication device, in response to receiving 702 the information. In some instances, executing 704 the control application may include waking up the control application when the application has gone to sleep or otherwise entered a dormant state e.g., when running in the background for a period of time without user input or other triggering event.

The method 700 can further include determining 706, by a processor 106 (FIG. 3) of the mobile communication device, a location of the mobile communication device in response to executing the control application. The mobile communication device can include a positioning system (see, e.g., positioning system 102 in FIG. 3). The positioning system can determine a current position of the mobile communication device. The positioning system can be any device or circuitry for analyzing the position of the mobile communication device. For example, the positioning system can determine a position by using one or more of inertial sensors, a satellite positioning system (e.g., GPS or GNSS), by using triangulation and/or proximity to network access points or other network components (e.g., cellular towers and/or access points) and/or other suitable techniques.

The method 700 can further include comparing 708 the determined 706 location of the mobile communication device to a location of the bounded area. For instance, by way of non-limiting example, the bounded area may be defined by a series of latitudes and longitudes that together form an outer perimeter of the bounded area. The latitude and longitude of the determined location can be compared to the latitudes and longitudes that form the outer perimeter of the bounded area to compare the determined location to the bounded area. In some implementations, comparing 708 can be performed by the control application. Based on a result of the comparison 708, the mobile communication device can determine whether the mobile communication device is located within the bounded area or outside of the bounded area.

Where the determined location corresponds with a location where the state of the movable barrier is to be affected, the method 700 can further include transmitting 710, by the mobile communication device, a signal to the movable barrier operator. Transmitting 710 the signal to the movable barrier operator can be performed indirectly, e.g., through the network 44 (FIG. 2). For example, the mobile communication device can include a communication interface that transmits a signal to the movable barrier operator (see, e.g., communication interface 108 in FIG. 3). The communication interface can include any circuits, components, software, etc. for communicating with the transceiver of the access control device. In some implementations, the communication interface can include for example, one or more of a communications controller, receiver, transceiver, transmitter, port, conductors, software and/or hardware for communicating data/information. The movable barrier operator can receive the transmitted 710 signal (e.g., at the communication circuitry 250). The movable barrier operator can then affect the state change of the movable barrier to open or close the movable barrier. It should be understood that in some instances, one or more of the steps described in method 700 may be omitted. For instance, in an embodiment, the mobile communication device can execute 704 the control application which can transmit 710 the signal to the movable barrier operator without performing the operation of determining 706 the location of the mobile communication device and without comparing 708 the determined location to the location of the bounded area. Yet other modifications to the method can be made without departing from the scope of the disclosure.

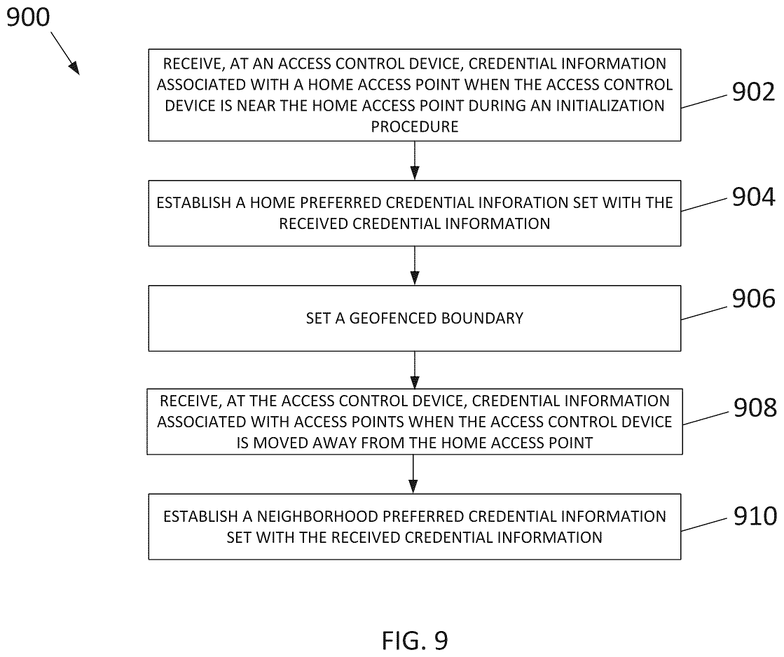

FIG. 9 illustrates a flow diagram of a method 900 of forming a catalogued whitelist of access points according to example embodiments of the present disclosure. In general, the method 900 will be described with reference to a system including the movable barrier operator 12, the mobile communication device 34, and the access control device 74 described above with reference to FIGS. 1 to 4. In addition, although FIG. 9 depicts steps performed in a particular order for purposes of illustration and discussion, the method discussed herein is not limited to any particular order or arrangement. One skilled in the art, using the disclosure provided herein, will appreciate that various steps of the method disclosed herein can be omitted, rearranged, combined, and/or adapted in various ways without deviating from the scope of the present disclosure.

The method 900 includes receiving 902, at the access control device, identifying information associated with access points when the access control device is near the home access point during an initialization procedure. For instance, upon powering up the access control device for the first time, the access control device can receive 902 one or more signals from nearby access points. These access points are typically located nearest to the driver's house.

The method 900 can further include establishing 904 a home preferred identifying information set with the received identifying information. In some instances, establishing 904 the home preferred identifying information set can be performed automatically by the access control device. For example, the access control device can automatically generate the home preferred identifying information set without user interaction. In other instances, establishing 904 the home preferred identifying information set can be performed at least in part by the user by selecting one or more of the received 902 identifying information for inclusion in the home preferred identifying information set. Where establishing 904 the home preferred identifying information set is performed at least in part by the user, the method can further include transmitting information associated with the received identifying information to the mobile communication device or another user device. The user can then establish 904 the home preferred identifying information set and the mobile communication device (or other user device) can transmit the home preferred identifying information set to the access control device to be stored for later use. In some instances, the home preferred identifying information set may be limited to a prescribed number of whitelisted access points (e.g., no more than 25 whitelisted access points). The home preferred identifying information set may be accessed (queried) by the access control device to determine whether the access control device (and thus the vehicle) is at the home.

In some instances, the home preferred identifying information set can include a classification schema. The classification schema can differentiate between different access points, such as between the home access point and other access points. In some implementations, the access control device can automatically assign the access point with the strongest RSSI as the home access point. In some instances, the access control device can communicate with the mobile communication device to provide a notification to the user to confirm the assignment of the home access point. In other implementations, the user can manually select the home access point based on the received identifying information.

The method 900 can further include setting 906 a geofenced boundary. The geofenced boundary may be set by the user, e.g., as part of the initialization process. In some implementations, the geofenced boundary may be set 906 automatically, or at least preliminarily, based on the home preferred identifying information set. That is, for example, the geofenced boundary may be set 906 based on a default value or values such as an estimated range of each received signal such that the broadcast access points associated with the received signals are within the geofenced boundary.

After the home preferred identifying information set is established and the geofenced boundary is set, the vehicle can be moved (driven) away from the home access point. The method 900 can further include receiving 908, at the access control device, identifying information associated with access points when the access control device is moved away from the home access point. As the vehicle moves, the access control device can receive 908 identifying information that was not previously received 902 as part of initialization. The further the vehicle travels, the greater the number of new access points that are detected by the access control device. The access control device can store information associated with the received signals associated with the new access points.

The method 900 can further include comparing the received 908 identifying information to the geofenced boundary set 906 during initialization. The access control device can then establish 910 a neighborhood preferred identifying information set with the newly received identifying information. In an embodiment, the neighborhood preferred identifying information set can be established 910 in a manner similar to the home preferred identifying information set. For instance, the access control device can automatically generate the neighborhood preferred identifying information set without user interaction. In another embodiment, the neighborhood preferred identifying information set can be established in a manner different than the home preferred identifying information set. The neighborhood preferred identifying information set can be used to detect when the access control device is near the home access point. In this regard, the movable barrier control system can initiate activation of the movable barrier operator to affect a state of the movable barrier in a timely manner such that, e.g., the movable barrier is already open by the time the vehicle arrives at the garage.

Other methods and steps of forming the access point whitelist may be utilized. For example, in an embodiment, the user can manually set both the home and neighborhood preferred identifying information sets on a mobile communication device or another user device. In some instances, one more steps of the method can be performed by the mobile communication device instead of at the access control device. Moreover, it may be possible to establish the neighborhood preferred identifying information set prior to establishing the home preferred identifying information set. In some instances, the access control device can learn and/or iteratively adjust the whitelisted access points or actions taken in response to detecting a whitelisted access point to more precisely control operation of the movable barrier operator without user intervention. For example, in some implementations, the method can further include removing previously whitelisted access points, e.g., in response to inactivity or lack of detection over a prescribed period of time (e.g., after 30 days of no actively received signal from the previously whitelisted access point). In certain instances, the whitelisted access points can be identified on the preferred identifying information set by a plurality of parameters, such as by SSID and a MAC address. In some instances, the whitelisted access points can be mapped or logged in a manner that allows the access control device to determine specific details associated with the vehicle's location with respect to the bounded area. For instance, when entering the bounded area from one entrance location a first whitelisted access point may be detected first, however, when entering the bounded area from a second entrance location a second whitelisted access point may be detected first. Based on which one of the first or second whitelisted access points is first detected, the access control device can determine the entry point into the bounded area. The access control device may operate differently based on the determined entry point. For example, where the time to reach the garage is different based on the utilized entry point (as determined, e.g., by the access control device through learning over a number of uses), the access control device may affect operation of the movable barrier operator differently. For the longer route, the access control device may wait to transmit the notification to the mobile communication device.

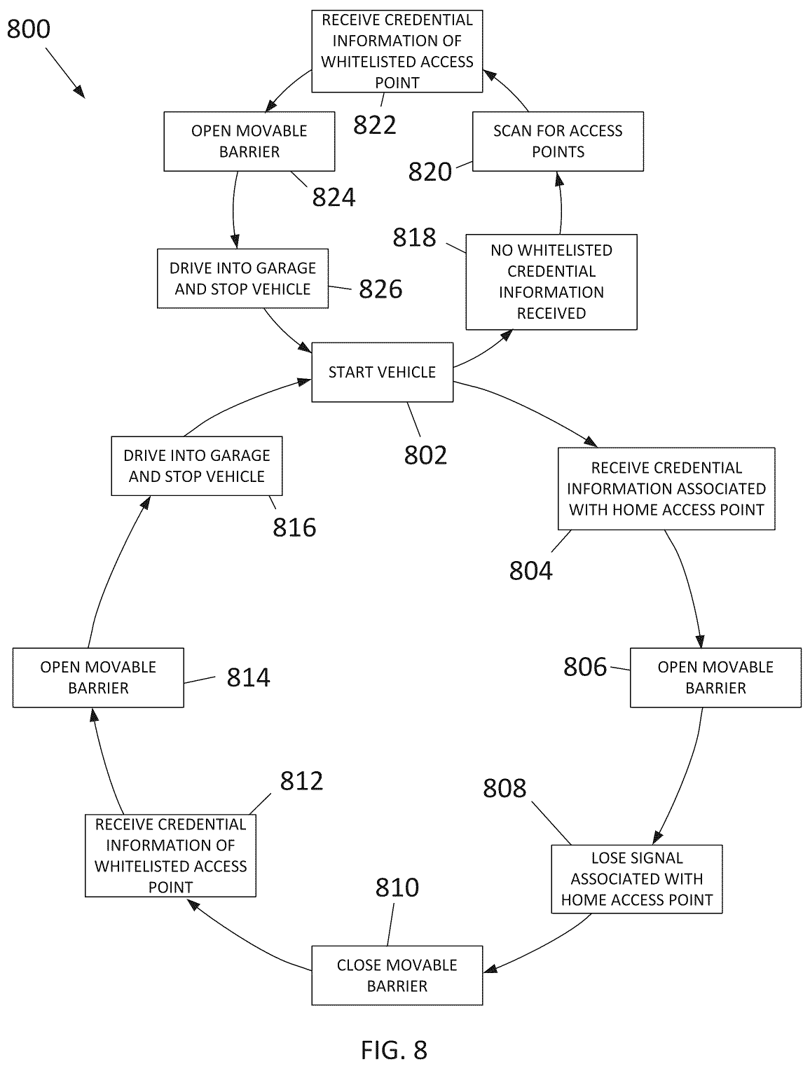

FIG. 8 is a diagram depicting autonomous operation 800 of a movable barrier operator in response to starting a vehicle in accordance with an example embodiment. The diagram shows two alternative processes in response to starting the vehicle. A first process is initiated when a whitelisted access point is detected, e.g., as part of monitoring 408 for access point(s) as part of the access control device startup procedure. More particularly, the first process is initiated in response to detecting a home access point. A second process is initiated when no whitelisted access points are detected, e.g., as part of monitoring 408 for access point(s) as part of the access control device startup procedure.

The vehicle may be started 802 by a user or driver, e.g., to travel to a destination, to affect an outcome described herein, and/or for another purpose. As described above, an access control device can be disposed in, at, or on the vehicle. The access control device can automatically receive power from the vehicle when the vehicle is started 802. After, or during, a startup procedure, the access control device can begin receiving identifying information associated with nearby access points. In instances where the vehicle is parked in a home garage, the access control device can receive 804 identifying information associated with the home access point. The determination that the received identifying information is associated with the home access point can be performed by first comparing a received identifying information to a preferred identifying information set which includes identifying information associated with the home access point. In some implementations, the home access point, or identifying information associated therewith, can be favored to indicate the home access point is the access point associated with a controllable device, e.g., a controllable movable barrier operator.

In response to receiving 804 the identifying information associated with the home access point, the access control device can cause the movable barrier operator to open 806 the movable barrier. For example, the access control device can transmit a signal to a mobile communication device (e.g., a user device such as a smart phone) causing the mobile communication device to send a signal to the movable barrier operator which causes the movable barrier operator to open 806 the movable barrier.

Once the movable barrier is open, the driver can move the vehicle from the garage. As the vehicle travels away from the home access point, signal strength as detected by the access control device weakens until such time that the access control device loses 808 signal associated the home access point. The access control device can cause the movable barrier operator to close 810 the movable barrier in response to the lost 808 signal. In some implementations, the access control device can cause the movable barrier operator to close 810 the movable barrier at a time prior to losing 808 the signal associated with the home access point. For example, in some implementations, the access control device can determine a relative signal strength indicator (RSSI) or other metric associated with the received signal(s). As the vehicle moves relative to the home access point, the RSSI changes. The determined RSSI or other metric can be used to estimate a relative distance between the access control device and the home access point. The access control device can be calibrated to transmit the notification to the mobile communication device based on detection of a threshold criterium, such as reaching a threshold RSSI. The driver (or an authorized representative) may be able to adjust the threshold criterium using the mobile communication device, at the home access point, at the movable barrier operator, or through another interface.

After the signal is lost 808 or the movable barrier operator has closed 810 the movable barrier, the access control device can continue to scan for signals including identifying information. At some future time, the vehicle returns to park in the garage. As the vehicle nears the garage, the access control device can receive 812 identifying information of a whitelisted access point. The whitelisted access point can include, for example, the home access point, an access point associated with a nearby house, dwelling, business, public infrastructure, or the like.

Upon receiving identifying information determined to be from a whitelisted access point, the access control device can transmit a signal to the mobile communication device, causing the mobile communication device to send a signal to the movable barrier operator which causes the movable barrier operator to open 814 the movable barrier. With the movable barrier clear of the vehicle, the vehicle can drive 816 into the garage and the user can stop the vehicle. In some instances, the access control device may transmit a signal to the mobile communication device, e.g., in response to losing power from the power source of the vehicle, that causes the mobile communication device to send a signal to the movable barrier operator to close the movable barrier. For instance, the access control device may include an internal power source that, when switched to, causes the access control device to transmit the signal to the mobile communication device. Alternatively, the driver can manually instruct the movable barrier operator to close the movable barrier. The process can then repeat when the vehicle is subsequently started 802 as the vehicle is in the garage and in range of the home access point.

In instances where the vehicle is not in range of the home access point when starting the vehicle, starting 802 the vehicle may not result in whitelisted identifying information being received 818 at the access control device. For example, where the vehicle is parked in a location that is remote from the driver's home such as a parking lot associated with a shopping center or a work office, the vehicle is not within range of the home access point or a bounded area associated with the home access point. The access control device can continue to scan 820 for access points until receiving 822 identifying information associated with a whitelisted access point. Upon receiving 822 the identifying information associated with the whitelisted access point, the access control device can transmit a signal to the mobile communication device, causing the mobile communication device to send a signal to the movable barrier operator which causes the movable barrier operator to open 824 the movable barrier. With the movable barrier open, the vehicle can drive 826 into the garage and the user can stop the vehicle. The process can then repeat when the vehicle is subsequently started 802, however, the vehicle is now in the garage and in range of the home access point. Thus, subsequently starting the vehicle will cause the access control device to receive 804 identifying information associated with the home access point.

Systems, apparatuses, and methods described herein allow for precise operation of a movable barrier operator using a mobile communication device without relying exclusively on the positioning system 102 (FIG. 3) of the mobile communication device. To conserve battery, positioning systems 102 of mobile communication devices often enter a dormant/sleep (inactive) mode when a positioning application on the mobile communication device is not in active use. Once in the sleep mode, the mobile communication device may not have record of a reliably precise location of the mobile communication device. When using the mobile communication device to facilitate access to a garage, it is generally undesirable to incur lag time associated with a dormant positioning system 102. For example, the vehicle may arrive at the garage prior to the positioning system 102 detecting entrance into the bounded area. Alternatively, the vehicle may exit the garage and drive a substantial distance before the positioning system 102 detects the vehicle out of the bounded area. Thus, the movable barrier remains undesirably open for a long period of time.

Using the access control device described herein to detect vehicle entrance and exit from a bounded area and to transmit a notification to the mobile communication device upon occurrence of such detected condition can reduce resource consumption (e.g., particularly battery depletion) on the mobile communication device and simultaneously provide more precise operation of the movable barrier operator.

Further aspects of the invention are provided by one or more of the following embodiments:

Embodiment 1. A method for affecting a state of a movable barrier, the method comprising: receiving, at an access control device, an identifying information from an access point, the access control device configured to be transported by a vehicle; comparing, by the access control device, the received identifying information to a preferred identifying information set; determining, by the access control device, a status of the vehicle relative to a bounded area associated with a controllable movable barrier operator based on the comparing; and transmitting, by the access control device, a notification including information associated with the determined status of the vehicle relative to the bounded area, the notification configured to cause a user device to execute a control application associated with the controllable movable barrier operator to affect a state of a movable barrier.

Embodiment 2. The method of any one or more of embodiments 1 or 5 to 8, wherein the method further comprises: initiating, by a processor of the access control device, a startup procedure of the access control device in response to the access control device receiving power from the vehicle; and monitoring, via the access control device, for the access point during the startup procedure.

Embodiment 3. The method of embodiment 2, further comprising: determining, via the access control device, that the vehicle is outside the bounded area based on the monitoring; and continuing to monitor, via the access control device, for the access point.

Embodiment 4. The method of embodiment 3, wherein transmitting the notification to the user device comprises transmitting a notification that the vehicle is within the bounded area, and wherein the notification transmitted in the notification causes the control application to drive the movable barrier operator to open the movable barrier.

Embodiment 5. The method of any one or more of embodiments 1 to 4 or 6 to 8, further comprising: monitoring, via the access control device, for the access point after determining that the vehicle is within the bounded area; and determining, via the access control device, that the vehicle is outside the bounded area based on the monitoring, wherein transmitting the notification including information comprises transmitting a notification that the vehicle is outside of the bounded area, and wherein the notification transmitted in the notification causes the control application to actuate the movable barrier operator to close the movable barrier.

Embodiment 6. The method of any one or more of embodiments 1 to 5, 7, or 8, wherein the preferred identifying information set comprises a unique identifier associated with received identifying information from an access point, and wherein comparing the received identifying information to the preferred identifying information set comprises comparing the received identifying information to the unique identifier.

Embodiment 7. The method of any one or more of embodiments 1 to 6 or 8, wherein the preferred identifying information set comprises a plurality of unique identifiers each unique identifier of the plurality of unique identifiers associated with a different access point, and wherein determining the status of the vehicle relative to the bounded area occurs when the received identifying information is associated with at least one unique identifier of the plurality of unique identifiers.

Embodiment 8. The method of any one or more of the preceding embodiments, wherein the preferred identifying information set is stored in a memory of the access control device.

Embodiment 9. A non-transitory computer-readable medium storing instructions which, when executed, cause performance of a method of affecting a state of a movable barrier, the method comprising: receiving, at a mobile communication device, information associated with a status of a vehicle relative to a bounded area, wherein the information is received from an access control device transported by the vehicle; executing a control application, by a processor of the mobile communication device, in response to receiving the information; determining, by the processor of the mobile communication device, a location of the mobile communication device in response to executing the control application; comparing, via the control application, the location determined by the mobile communication device to the bounded area; and transmitting, by the mobile communication device, a signal to the movable barrier operator based on the comparing.

Embodiment 10. The non-transitory computer-readable medium of embodiment 9, further comprising: determining, by the control application, that the mobile communication device is within the bounded area based on the comparing, wherein transmitting the signal to the movable barrier operator causes the movable barrier operator to open a movable barrier.

Embodiment 11. The non-transitory computer-readable medium of embodiment 9 or 10, further comprising: determining, by the control application, that the mobile communication device is outside the bounded area based on the comparing, wherein transmitting the signal to the movable barrier operator causes the movable barrier operator to close a movable barrier.

Embodiment 12. An access control device configured to be transported by a vehicle, the access control device comprising: a transceiver configured to communicate with a mobile communication device; and a processor in operable communication with a non-transitory computer-readable medium storing instructions, wherein the processor upon execution of the instructions is configured to: receive, from the transceiver, an identifying information associated with an access point; compare the identifying information to a preferred identifying information set stored in the non-transitory computer-readable medium; determine a status of the vehicle relative to a bounded area associated with a controllable movable barrier operator based on the comparing; and transmit, to a mobile communication device, a notification including information associated with the status of the vehicle relative to the bounded area, the notification configured to cause the mobile communication device to execute a control application associated with the controllable movable barrier operator to affect a state of a movable barrier.

Embodiment 13. The access control device of embodiment 12, wherein the access control device further comprises a power input configured to receive power from the vehicle.

Embodiment 14. The access control device of embodiment 13, wherein the processor is configured to: initiate a startup procedure in response to the access control device receiving power at the power input; and monitor for the access point during the startup procedure.

Embodiment 15. The access control device of embodiment 14, wherein the processor is configured to: determine that the vehicle is outside the bounded area based on the processor monitoring for the access point during the startup procedure; and continue to monitor for the access point after the startup procedure.

Embodiment 16. The access control device of any one or more of the embodiments 12 to 15 or 17 to 20, wherein the processor is configured to: monitor for a received signal transmitted by the access point after determining that the vehicle is within the bounded area; and determine that the vehicle is outside the bounded area based on the processor continuing to monitor for the access point, wherein the notification to the mobile communication device indicates that the vehicle is outside of the bounded area, and wherein the notification causes the control application to actuate the movable barrier operator to close the movable barrier.

Embodiment 17. The access control device of any one or more of embodiments 12 to 16 or 18 to 20, wherein the preferred identifying information set comprises a plurality of unique identifiers each unique identifier of the plurality of unique identifiers associated with a different access point.

Embodiment 18. The access control device of any one or more of embodiments 12 to 17, 19, or 20, wherein the processor is further configured to determine a relative signal strength indicator ‘RSSI’ of a signal including the identifying information, and wherein to transmit the notification to the mobile communication device is performed based on the RSSI that was determined.

Embodiment 19. The access control device of any one or more of embodiments 12 to 18 or 20, wherein the preferred identifying information set comprises a home preferred identifying information set established automatically by the access control device during an initialization procedure, wherein the home preferred identifying information set includes identifying information associated with a home access point.

Embodiment 20. The access control device of any one or more of embodiments 12 to 18, wherein the preferred identifying information set further comprises a neighborhood preferred identifying information set established after the home preferred identifying information set is established, and wherein the neighborhood preferred identifying information set comprises identifying information associated with access points around the home access point.

The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A method for affecting a state of a movable barrier operator, the method comprising:
receiving, at an access control device, a identifying information from an access point, the access control device configured to be transported by a vehicle;
comparing, by the access control device, the received identifying information to a preferred identifying information set;
determining, by the access control device, a status of the vehicle relative to a bounded area associated with a controllable movable barrier operator based on the comparing; and
transmitting, by the access control device, a notification including information associated with the determined status of the vehicle relative to the bounded area to a user device, the notification configured to cause the user device to execute a control application associated with the controllable movable barrier operator to affect a state of a movable barrier.

2. The method of claim 1, wherein the method further comprises:
initiating, by a processor of the access control device, a startup procedure of the access control device in response to the access control device receiving power from the vehicle; and
monitoring, via the access control device, for the access point during the startup procedure.

3. The method of claim 2, further comprising:
determining, via the access control device, that the vehicle is outside the bounded area based on the monitoring; and
continuing to monitor, via the access control device, for the access point.

4. The method of claim 3, wherein transmitting the notification to the user device comprises transmitting a notification that the vehicle is within the bounded area, and wherein the notification transmitted in the notification causes the control application to drive the movable barrier operator to open the movable barrier.

5. The method of claim 1, further comprising:
monitoring, via the access control device, for the access point after determining that the vehicle is within the bounded area; and
determining, via the access control device, that the vehicle is outside the bounded area based on the monitoring,
wherein transmitting the notification including information comprises transmitting a notification that the vehicle is outside of the bounded area, and wherein the notification transmitted in the notification causes the control application to actuate the movable barrier operator to close the movable barrier.

6. The method of claim 1, wherein the preferred identifying information set comprises a unique identifier associated with received identifying information from an access point, and wherein comparing the received identifying information to the preferred identifying information set comprises comparing the received identifying information to the unique identifier.

7. The method of claim 1, wherein the preferred identifying information set comprises a plurality of unique identifiers each unique identifier of the plurality of unique identifiers associated with a different access point, and wherein determining the status of the vehicle relative to the bounded area occurs when the received identifying information is associated with at least one unique identifier of the plurality of unique identifiers.

8. The method of claim 1, wherein the preferred identifying information set is stored in a memory of the access control device.

9. A non-transitory computer-readable medium storing instructions which, when executed, causes performance of a method of affecting a state of a movable barrier operator, the method comprising:
receiving, at a mobile communication device, information associated with a status of a vehicle relative to a bounded area, wherein the information is received from an access control device transported by the vehicle;
executing a control application, by a processor of the mobile communication device, in response to receiving the information;
determining, by the processor of the mobile communication device, a location of the mobile communication device in response to executing the control application;
comparing, via the control application, the location determined by the mobile communication device to the bounded area;
transmitting, by the mobile communication device, a signal to the movable barrier operator based on the comparing.

10. The non-transitory computer-readable medium of claim 9, further comprising:
determining, by the control application, that the mobile communication device is within the bounded area based on the comparing,
wherein transmitting the signal to the movable barrier operator causes the movable barrier operator to open a movable barrier.

11. The non-transitory computer-readable medium of claim 9, further comprising:
determining, by the control application, that the mobile communication device is outside the bounded area based on the comparing,
wherein transmitting the signal to the movable barrier operator causes the movable barrier operator to close a movable barrier.

12. An access control device configured to be transported by a vehicle, the access control device comprising:
a transceiver configured to communicate with a mobile communication device; and
a processor in operable communication with a non-transitory computer-readable medium storing instructions, wherein the processor upon execution of the instructions is configured to:
receive, from the transceiver, a identifying information associated with an access point;
compare the identifying information to a preferred identifying information set stored in the non-transitory computer-readable medium;
determine a status of the vehicle relative to a bounded area associated with a controllable movable barrier operator based on the comparing; and
transmit, to a mobile communication device, a notification including information associated with the status of the vehicle relative to the bounded area, the notification configured to cause the mobile communication device to execute a control application associated with the controllable movable barrier operator to affect a state of a movable barrier.

13. The access control device of claim 12, wherein the access control device further comprises a power input configured to receive power from the vehicle.

14. The access control device of claim 13, wherein the processor is configured to:
initiate a startup procedure in response to the access control device receiving power at the power input; and
monitor for the access point during the startup procedure.

15. The access control device of claim 14, wherein the processor is configured to:
determine that the vehicle is outside the bounded area based on the processor monitoring for the access point during the startup procedure; and
continue to monitor for the access point after the startup procedure.

16. The access control device of claim 12, wherein the processor is configured to:
monitor for a received signal transmitted by the access point after determining that the vehicle is within the bounded area; and
determine that the vehicle is outside the bounded area based on the monitoring,
wherein the notification to the mobile communication device indicates that the vehicle is outside of the bounded area, and wherein the notification causes the control application to drive the movable barrier operator to close the movable barrier.

17. The access control device of claim 12, wherein the preferred identifying information set comprises a plurality of unique identifiers each unique identifier of the plurality of unique identifiers associated with a different access point.

18. The access control device of claim 12, wherein the processor is further configured to determine a relative signal strength indicator ‘RSSI’ of a signal including the identifying information, and wherein to transmit the notification to the mobile communication device is performed based on the RSSI that was determined.

19. The access control device of claim 12, wherein the preferred identifying information set comprises a home preferred identifying information set established automatically by the access control device during an initialization procedure, wherein the home preferred identifying information set includes identifying information associated with a home access point.

20. The access control device of claim 19, wherein the preferred identifying information set further comprises a neighborhood preferred identifying information set established after the home preferred identifying information set is established, and wherein the neighborhood preferred identifying information set comprises identifying information associated with access points around the home access point.
